(19) United States
(12) Patent Application Publication
(10) Pub. No.: US 2005/0102158 A1
(43) Pub. Date: May 12, 2005

(54) System for medical data collection

(75) Inventor: Chris Maeda, Salem, NH (US)

Correspondence Address: CHRISTOPHER M. MAEDA, 215 S. BROADWAY 241, SALEM, NH, 03079, US

(73) Assignee: GRANITE HEALTH SYSTEMS, INC., Salem, NH (US)

(21) Appl. No.: 10/605,947

(22) Filed: Nov. 7, 2003

(51) Int. Cl. G06F 17/60

(52) U.S. Cl. 705/2

(57) ABSTRACT

Apparatus and method is disclosed for a data collection and monitoring system that utilizes a remote collection unit which has contained therein interaction software that allows the user to define and import data collection scenarios, capture data, update data, query data, and notify the user of adverse conditions triggered by the entered data values. The system has a means to allow transfer of the collected data to a main computer database for further review, reporting, and distribution purposes.

### BACKGROUND OF INVENTION

1. Field of the Invention

This invention relates generally to computer means for collecting data, storing data, reviewing data, and organizing data for the purposes of collecting data pertaining to clinical trials. More particularly, this invention relates to a remote collection unit that allows operators the ability to electronically gather data from multiple locations, validate and verify the collected data, automatically recheck out-of-range data, call up procedural information, and to electronically transfer the collected data to a main computer system for consolidation and analysis. In addition, this invention discloses a method by which details pertaining to the clinical trial protocol studies can be defined and stored in a persistent design repository, then transmitted to the remote control units as either new protocol studies, or updates to existing protocol studies.

2. Brief Description of the Prior Art

Typical data collection techniques start with a detailed definition of the procedures and business rules which determine which data are needed to fulfill the business purposes. In the case of the health care industry, the procedures and business rules are influenced or even defined by the Food and Drug Administration (FDA). The Federal regulations governing electronic records in clinical trials (21 CFR Part 11) were issued on March 1997. Randomized controlled clinical trials are the preferred method for evaluating medical interventions. The use of outdated paper-based processes is a major contributor to the cost and significant length of time associated with clinical trials.

In a paper-based data collection process, at each investigative center of a multicenter trial, clinical investigators observe the test subjects and their observations are recorded on source documents (medical records). Then Clinical Research Coordinators (CRCs) fill out paper Case Report Forms (CRFs) based on the source documents. The CRFs are then taken to the coordinating center by a clinical research associate (CRA), where they are entered into a central database using redundant data entry techniques. There, the data undergo validation and quality control checks. For audit purposes, each investigative site must maintain archived copies of the CRFs, as well as archives of the source documents. The inefficiency in the data capture process can be seen in the fact that trial data is kept on paper forms until the final data entry step. Research coordinators and investigative sites must record observations on paper forms. There are delays before the paper forms arrive at the coordinating site. Problems in the data are not flagged until data entry time and can only be corrected at significant effort and cost. In addition, the investigative sites are required to archive the paper forms separately from the central trial database to enable future data quality audits.

Web-based data capture is one alternative to paper based data capture. Instead of sending paper CRFs to the coordinating site, the CRCs key data directly into the trial database using browsers connected over the Internet. This approach allows data to be validated much closer to the point of observation and much earlier in the trial process. A key flaw in these web-based data capture systems is the change of workflow required to adopt them. In the paper-based process, CRCs can complete paper CRFs while interacting with patients. In the web-based process, CRCs must complete the web-based CRFs at a data entry terminal that is typically separate from patient care areas. Thus, the benefits of early data capture and validation are attenuated by the need to retrain CRCs and the fact that the patients and the data entry terminals are in different locations. A second flaw in web-based data capture systems is that investigative sites are still required to maintain paper CRF archives, providing no cost incentive for the investigative sites to adopt web-based technology.

Other computers systems have been disclosed that basically provide methods and apparatus for clinical trial related data capture. U.S. Pat. No. 6,566,999 issued to Kloos discloses a back-end clinical definition using a back-end clinical data management system (CDMS) where the back-end clinical definition is automatically converted into a Remote Data Entry (front-end) study definition. The front-end study definition is transferred to a remote computer hosting a front-end RDE product where it is used to regulate the acquisition of clinical data. During the back-end clinical definition to front-end study definition conversion process, a conversion map is created. The conversion map allows for the automated conversion of clinical data acquired using the front-end RDE product to a format that can be read by the back-end CDMS. Clinical data is retrieved from remote computers hosting a front-end RDE product in an automated manner without manual back-end clinical definition/front-end study definition conflict resolution.

Also see U.S. Pat. No. 6,496,827 issued to Kozam which discloses a centralized collection of geographically distributed data using a system which takes advantage of an interactive programming language, such as Java. TM and existing wide area networks, such as the Internet including the World Wide Web, to collect high quality data in an information center.

All the systems described have at least one of several major problems not present in the instant patent. One significant drawback is that the method of collecting data for introduction into the computer system is either via manual collection or via a non-portable computer. It is desirable for a plurality of Remote Collection Units running an embedded Target Application Binary that users could take out into the field to collect data. The second significant drawback is the method of updating the software on the Remote Collection Unit. The systems described above have fixed software definitions that are difficult to update. The Authoring Tool in the present invention generates Target Application Binaries based on the Study Protocol data stored in design repositories in persistent storage. The Target Application Binary is deployed to the Remote Collection Units, and can easily be updated as the Study Protocols and the resulting design repositories change or evolve over time. The third significant drawback is the reliance on third party commercial applications.

### SUMMARY OF INVENTION

There is provided by this invention a data collection and monitoring system having a plurality of Remote Computer Units running Target Application Binaries which guide the users through procedural steps and data collection for a specified Study Protocol, and one or more or more centralized data repositories for the persistent storage of aggregated data collected by the Remote Collection Units. The Remote Collection Unit has a means to allow automatic transfer of the collected data via a Data Import and Export Module to a centralized data repository for further review, reporting, and distribution purposes. The present invention also discloses a Study Protocol Authoring Tool, which provides an interface for specifying the forms, business rules, and logic associated with a specific Study Protocol. The data associated with the Study Protocol is also stored in a centralized data repository, where it is used as input by a Generator to create Target Application Source Code, which is then processed by a Compiler to create a Target Application Binary, which is transferred to the Remote Collection Units and used to operate the data collection for the Study Protocol.

### BRIEF DESCRIPTION OF DRAWINGS

FIG. 1 is a basic block diagram of the computer system incorporating the principles of this invention;

FIG. 2 shows one output of the invention, the Target Application Binary;

FIG. 3 shows potential deployment scenarios supported by the invention;

FIG. 4 shows an object model of the Study Protocol Description data, drawn as a Class Diagram in the Unified Modeling Language.

### DETAILED DESCRIPTION

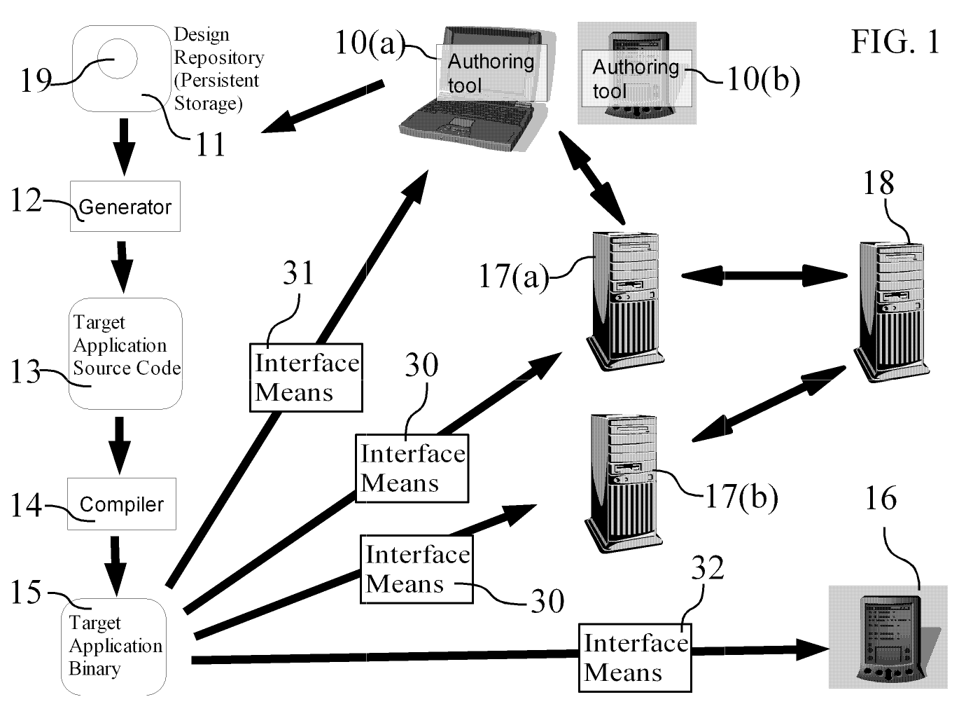

FIG. 1 shows a block diagram of the invention. An Authoring Tool (10a or 10b) located on any computing device is used to configure a description of the study protocol. The description describes information pertaining to the study protocol and can include, but is not limited to, the number and types of visits in the study, definitions of the forms that are to be filled out during each visit, validation and action rules for each field of each form, and how the fields of each form are grouped and displayed on screens in the destination platform.

When the Study Protocol Description (19) has been completed, the Authoring Tool (10a, 10b) stores the Study Protocol Description (19) in the Design Repository (11), which is kept in persistent storage implemented in some structured form such as a relational database or structured document repository. Storage of the Study Protocol Description (19) in the Persistent Design Repository (11) enables the Study Protocol Description (19) to be modified and to evolve over time.

The Generator (12) utilizes the Study Protocol Description (19) stored in the Persistent Design Repository (11) to create the Target Application Source Code (13). The Target Application Source Code (13) is the source code for an application designed to collect and manage the data specified by the Study Protocol Description (19) defined above using the Authoring Tool (10a, 10b) and stored in the Persistent Design Repository (11). The Target Application Source Code (13) utilizes APIs supplied by the destination platform, which can be one of a plurality of any type or combination of computing devices such as a server, a notebook computers, or a handheld computer. The program logic implemented in the Target Application Source Code is specific to the Study Protocol Description (19) defined above using the Authoring Tool (10a, 10b) and stored in the Persistent Design Repository (11).

The Compiler (14) takes the Target Application Source Code (13) and compiles it into a Target Application Binary (15) for deployment on the destination platform. J2EE is one platform that can be utilized to implement the present invention. J2EE is designed for distributed, web-based applications running on web server and application server computers; it provides facilities for deploying applications as binary archives containing compiled Java class files. If the destination platform is J2EE, the present invention uses a Java compiler for J2EE to produce a J2EE web application packaged in a binary archive file. J2ME is another platform that can be utilized to implement the present invention. J2ME is designed for handheld computers with or without network connectivity. J2ME provides more limited programming libraries compared to J2EE, and also requires its binary archives to undergo security checking before being deployed on the handheld device. Moreover, J2ME's application deployment facilities are determined by the capabilities of the handheld computer; in particular, what kind of network connectivity is available on the device. If the destination platform is J2ME, the present invention uses a Java compiler and a byte code preverifier and emits a J2ME application packaged as a preverified archive file.

After the generation of the Target Application Binary (15), deployment may take place to any destination platform, including one or more servers (17a, 17b), notebook computers (10a, 10b), or Handheld Computers (16) using the standard deployment mechanisms for each destination platform. Each of the deployment mechanisms uses an interface means to communicate between the computer containing the Target Application Binary (15) and the destination platform. If the destination platform is a handheld computer running J2ME, the Target Application Binary (15) can be deployed to one or more of a plurality of J2ME Handheld Computers (16a-16c) utilizing an Interface Means (32) of either a wired or wireless network connection.

If the destination platform is a Server (17a, 17b) running J2EE, the Target Application Binary (15) can be deployed to the Server (17a, 17b) using the application deployment tools provided by the J2EE application server utilizing an Interface Means (30) of either a wired or wireless network connection. These management tools are typically used to upload the Target Application Binary (15) to the server and otherwise prepare it for execution on the server.

If the destination platform is a notebook computer (10a, 10b) running J2ME or J2EE, the Target Application Binary (15) can be deployed to the notebook computer (10a, 10b) utilizing an Interface Means (31) of either a wired or wireless network connection.

Once deployed to any destination platform, the Target Application Binary (15) can be used to collect clinical data via one or more of a plurality of J2ME Handheld Computers (16a-16c) or a web browser (18) located on any computer device to collect clinical data within the parameters set by the Study Protocol Description (19) defined above using the Authoring Tool (10a, 10b) and stored in the Persistent Design Repository (11).

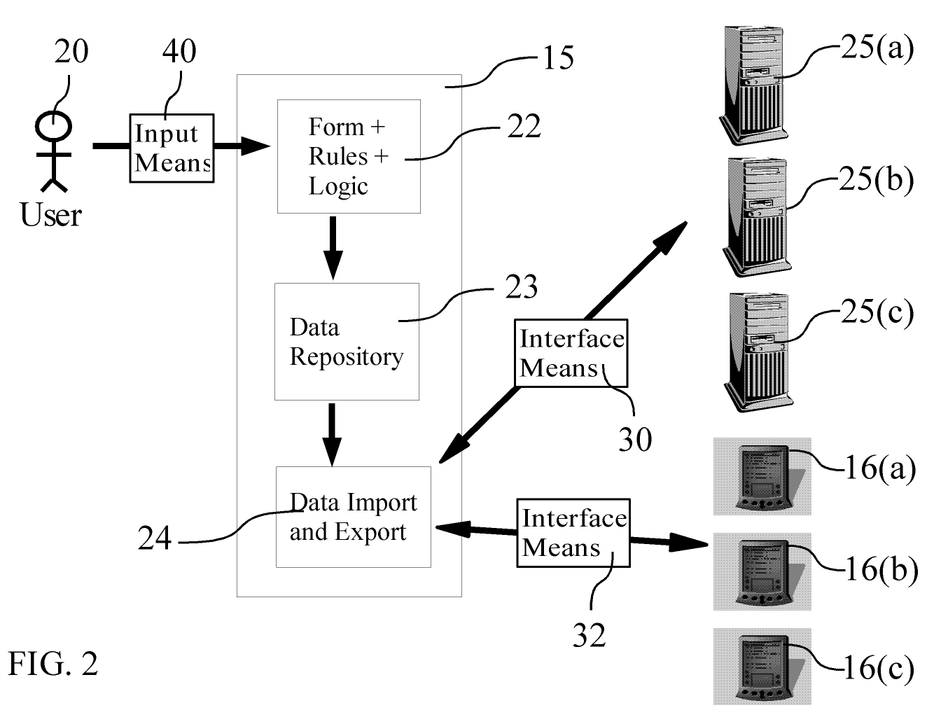

FIG. 2 shows one output of the present invention generated by the operation of the Target Application Binary (15) deployed on any destination platform. The figure assumes that the Target Application Binary (15) has already been deployed using the standard facilities available in each destination platform. The User (20), frequently a Clinical Research Coordinator, enters data into the Forms Module (22) implemented by the Target Application Binary (15) via the Input Means (40). The Input Means may take the form of an electronic stylus, keyboard, or any other data input mechanism supported by the destination platform on which the Target Application Binary (15) was deployed. The Forms Module (22) verifies that the data provided by the User (20) meets any validation criteria specified in the Study Protocol Description (19), which was defined using the Authoring Tool (10a, 10b) and stored in the Persistent Design Repository (11).

Assuming the data are valid, the Forms Module (22) saves the data in the Data Repository (23). The Forms Module (22) also provides a mode where the User (20) may view and edit previously entered data. When the data are edited, the Data Repository (23) stores the edits as amendments to the original data in order to preserve a complete history and audit trail of the data.

Periodically, the User (20) invokes the Data Import and Export module (24) to upload the data to one or more of a plurality of centralized Data Repositories (25a-25c) utilizing an Interface Means (30) of either a wired or wireless network connection. Any individual Data Repository (25a-25c) might be managed by an investigative site (e.g. a research hospital or clinic) or by the sponsor of the clinical trial. The User (20) can also invoke the Data Import and Export module (24) to import data from other data repositories; for example, one or more of a plurality of site-managed or sponsor-managed data repositories (25a-25c), or another instance of the Target Application Binary running on one or more of a plurality of handheld computing devices (16a-16c).

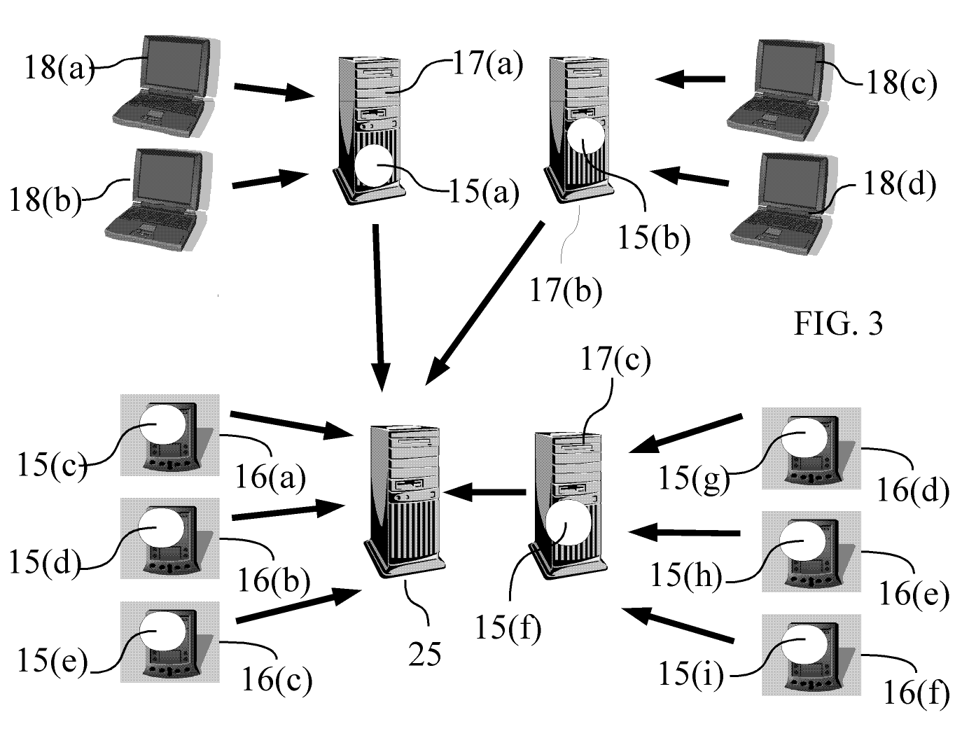

FIG. 3 shows the range of deployment scenarios supported by the present invention. The present invention allows any number of target application binary instances to be running on any number of computers and to aggregate their data on one or more shared data depositories.

In the upper left corner of FIG. 3, an instance of the Target Application Binary (15a) has been deployed on one of a plurality of web servers (17a) running an application platform such as J2EE. One or more from a plurality of computers running web browser clients (18a-18b) can collect and manage clinical data simultaneously. Periodically, the clinical data collected on this server computer (17a) can be uploaded to a site-managed or sponsor-managed data repository (25).

In the upper right corner of FIG. 3, the Target Application Binary (15b) has been deployed on an additional server computer (17b) and is being used by additional client computers (18c-18d). This server also periodically uploads its data to a site-managed or sponsor-managed data repository (25).

In the lower left corner of FIG. 3, a Target Application Binary (15c-15e), generated and compiled for a handheld destination platform such as J2ME, has been deployed on a plurality of Handheld Computers (16a-16c). These handheld computers are used to capture clinical data and to periodically upload it to a data repository (25) where the data can be aggregated and managed. Moreover, the data repository (25) can be the same one used by the web server computers in the upper half of the diagram.

The lower right corner of FIG. 3 illustrates a Target Application Binary (15f), generated and compiled for a server application platform like J2EE, and deployed on a web server computer (17c). In addition, a Target Application Binary (15g-15i), generated and compiled for a handheld destination platform such as J2ME, has been deployed on a plurality of Handheld Computers (16d-16f). The Handheld Computers (16d-16f) are used to capture clinical data and to upload that data to the Data Import and Export Module (24) of the Target Application Binary (15f) deployed on the server computer (17c). Thus, the present invention can also be executed in hierarchical configurations where one or more of a plurality of Handheld Computers (16d-16f) uploads data to a site-managed repository (17c), and the site-managed server (17c), in turn, uploads data to a sponsor-managed repository (25).

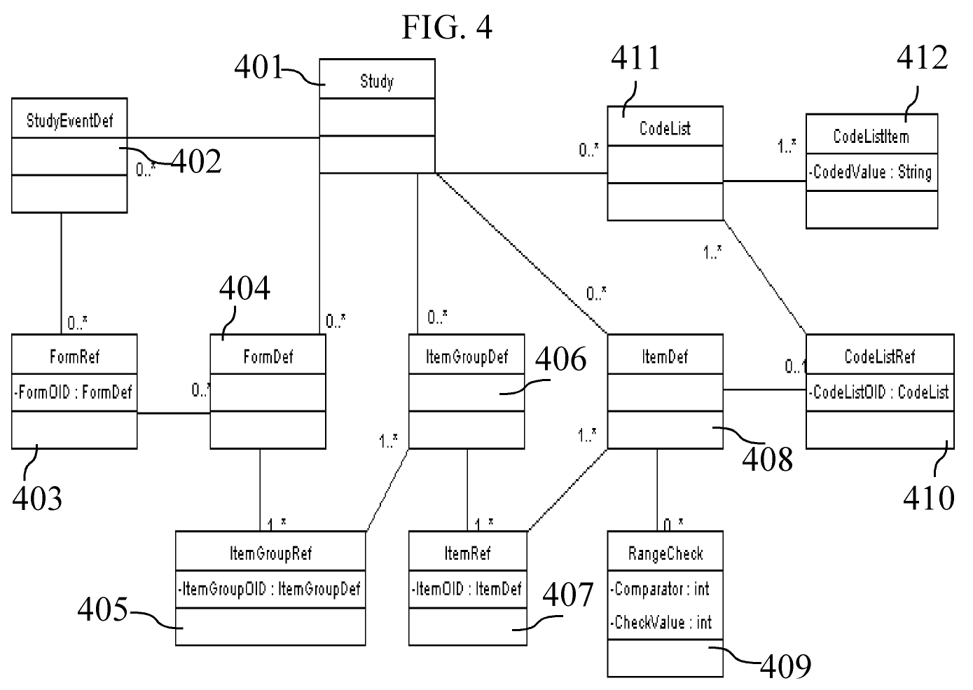

FIG. 4 shows an object model of the Study Protocol Description data, drawn as a Class Diagram in the Unified Modeling Language. This diagram represents in detail the structure of the data managed by the Authoring Tool (10a, 10b). The object model is based on the Operational Data Model standard (ODM Version 1.2) developed by the Clinical Data Interchange Standards Consortium (CDISC) [reference]. Persons skilled in the art will be able to construct said Authoring Tool based on the object model in this figure.

The Study class (401) represents the complete Study Protocol Description. The Study class (401) is comprised of the following components: StudyEventDef (402) classes, FormDef (404) classes, ItemGroupDef (406) classes, ItemDef (408) classes, and CodeList (411) classes. The Association arcs from the Study class (401) to each of its component classes (402, 404, 406, 408, 411) are labeled with “0 . . . *” which denotes that the Study class (401) may be comprised of zero or more of each component class (402, 404, 406, 408, 411).

The ItemDef class (408) represents a single datum to be collected. For example, a patient's age, the current date, a patient's pulse. The ItemDef class (408) contains a number of attributes, such as the type of the datum (e.g. whether it is a number, text string, date, or time), its length, and any constraints that must be met by the datum. The RangeCheck class (409) represents simple constraints on the value of the datum; for example, “less than 5”.

Alternatively, the datum may be drawn from a list of codes. The CodeList class (411) represents a list of codes. Code lists may be used to represent different kinds of illnesses or different kinds of treatment. Each CodeList (411) is comprised of multiple CodeListItem classes (412). Each CodeListItem (412) represents one element of the code list. If the datum for a given ItemDef (408) is to be drawn from a given CodeList (411), the ItemDef (408) has a CodeListRef (410) that references the CodeList (411) for the ItemDef (408) in question. Note that the associations are defined so that each ItemDef (408) may be drawn from zero or one CodeList (411) but a CodeList (411) may be used by any number of ItemDef's (408).

Related ItemDef (408) objects are grouped by ItemGroupDef (406) objects. For example, two ItemDef (408) objects might represent the systolic and diastolic components of a patient's blood pressure. A single ItemGroupDef (406) would group them into unit that could be used and reused in multiple forms. Each ItemGroupDef (406) is comprised of one or more ItemRef (407) objects, which each reference a single ItemDef (408) object. The associations are defined such that each ItemGroupDef (406) must consist of one or more ItemRef (407) objects; each ItemDef (408) can be used by multiple ItemGroupDef (406) objects.

One or more ItemGroupDef (406) objects are grouped into a FormDef (404) class. Each FormDef (404) consists of one or more ItemGroupRef (405) objects, which each reference a single ItemGroupDef (406). For example, ItemGroupDef (406) objects representing blood pressure data and blood cholesterol data might be grouped into a single FormDef (404). The associations are defined such that each FormDef (404) must consist of one or more ItemGroupRef (405) objects; each ItemGroupDef (406) can be used by multiple ItemGroupRef (405) objects.

The StudyEventDef (402) class represents the scheduled and unscheduled events in the Study (401). For example, a complete study protocol might consist of the patient visiting a clinic 5 times over the course of several weeks. Each of these visits would be modeled as a StudyEventDef (402) object in the Study (401) description. During each visit, the study protocol specifies which forms should be completed. The FormRef class (403) models this data. Each StudyEventDef (402) is comprised of zero or more FormRef (403) objects. Each FormRef (403) references a single FormDef class (404), which defines the data collected by the form.

In the preferred embodiment of the invention, the Study Protocol Description would be representing using relational database tables corresponding to each class in object model.

The following use cases describe how the present invention might be used in the field.

### USE CASE # 1A—CRF INPUTS RECORD IN THE FIELD, WEB-BASED EMBODIMENT

User (20) authenticates to the J2EE application server (17). Then User (20) keys the data into the fields of the Forms Module (22) that is displayed in the browser (18). When the data have been keyed in, the User (20) submits the populated Forms Module (22) to the Target Application Binary (15) running on the J2EE application server (17). Upon submission, the Target Application Binary (15) validates the data and creates a submission record in a structured format, such as XML, that contains the validated submission data, the submitting user's identity, and a digital signature created from the submission data, the user's identity, and a time/date stamp.

### USE CASE # 1B—CRF INPUTS INVALID DATA RECORD IN THE FIELD, WEB-BASED EMBODIMENT

User (20) authenticates to the J2EE application server (17). Then User (20) keys the data into the fields of the Forms Module (22) that is displayed in the browser (18). When the data have been keyed in, the user (20) submits the populated Forms Module (22) to the Target Application Binary (15) running on the J2EE application server (17). Upon submission, the Target Application Binary (15) validates the data. If any of the data are invalid, the Target Application Binary (15) displays the populated form with appropriate diagnostic messages that allow the User (20) to correct the invalid data. When the User (20) corrects and resubmits the data to the Target Application Binary (15), an submission record in a structured format, such as XML, is created and stored as in Use Case # 1a above.

### USE CASE # 1C—CRF INPUTS RECORD IN THE FIELD, J2ME HANDHELD EMBODIMENT

User (20) invokes the Target Application Binary (15) and keys the data into the fields of the Forms Module (22) that is displayed in the Handheld Computer (16). Because of the screen size limitations of handhelds, only a subset of the input fields can be displayed at once. The Handheld Computer (16) validates the data as they are input and only allows the User (20) to display new data fields when the data for the current fields have been validated successfully. When all the data have been keyed in, the Handheld Computer (16) creates a binary submission record in its internal record store that consists of the validated submission data, the submitting user's identity, and a digital signature created from the submission data, the user's identity, and a time/date stamp.

### USE CASE # 1D—CRF INPUTS INVALID DATA RECORD IN THE FIELD, J2ME HANDHELD EMBODIMENT

User (20) invokes the Target Application Binary (15) and keys the data into the fields of the Forms Module (22) that is displayed in the Handheld Computer (16). Because of the screen size limitations of handhelds, only a subset of the input fields can be displayed at once. The Handheld Computer (16) validates the data as they are input and only allows the user (20) to display new data fields when the data for the current fields have been validated successfully. If the User (20) enters invalid data, the Target Application Binary (15) will immediately mark the data as invalid and require the User (20) to correct the data before moving on to the next field. Once the User (20) has entered validated data for all fields in the form, the Handheld Computer (16) will create and store a binary submission record in its internal record store as in Use Case # 1c above.

### USE CASE # 2—DATA ARE CONSOLIDATED ON BACK END

In FIG. 3, one or more of a plurality of Handheld Computers (16a-16c) are used to collect data from a number of trial subjects. The data collected must be aggregated to one or more Data Repositories (25a-25c) managed by an investigative site (e.g. a research hospital or clinic) or by the sponsor of the clinical trial to enable subsequent analysis. The User (20) of the Handheld Computer (16) initiates a network connection to Data Repository (25) and authenticates. The network connection can be made using any technology such as serial data connection, wired local-area network connection, or wireless network connection. Once the User (20) has connected and authenticated to the Data Repository (25), the Data Import and Export Utility (24) running on the Handheld Computer (16) transforms the binary submission records into digitally signed documents in a structured format, such as XML, and transmits them over the network connection. The means for merging the submission documents into the Data Repository (25) is any clinical data management system that has facilities for importing documents in a structured format, such as XML. When the Data Repository (25) receives a document in a structured format, such as XML, it verifies the document's digital signature. If the Data Repository (25) successfully verifies the signature, it adds the document to its permanent storage. If the Data Repository (25) does not verify the digital signature, it returns an error code to the Handheld Computer (16) and takes no further action.

As shown in FIG. 3, the present invention allows server-to-server data consolidation as well. Server to server consolidation would be commonly used where clinical data are collected at an investigative site and uploaded to a central trial management server. In this scenario, a site-wide system (17a, 17b, or 17c in FIG. 3) connects to a trial-wide data repository (25) and the site data located is then consolidated for the trial. In an environment with multiple Data Repositories (25a-25c), each individual repository may be managed by different entities, and thus is likely communicating over wide-area network links. Each of the plurality of Data Repositories (25a-25c) should communicate using secure connections; in the preferred embodiment, Secure HTTP with bi-directional certificate-based authentication [c.f. RFC 2246]. Once the secure channel is established between the site-wide (17a-17c) and the trial-wide Data Repository (25), the site-wide servers asynchronously upload their submission documents in a structured format, such as XML, to the trial-wide Data Repository (25a-25c). Upon receiving the submission documents, the trial-wide Data Repository (25a-25c) attempts to verify the digital signatures of the documents. If the Data Repository (25) successfully verifies the signature, it adds the submission document to its permanent storage. If the Data Repository (25) does not verify the digital signature, it returns an error code to the site-wide server (17) and takes no further action.

### USE CASE # 3—AUTHORING OF FORMS FOR CLINICAL STUDIES

To create forms for a clinical study, the user uses an Authoring Tool (10a, 10b) running on a handheld computer, laptop computer, or a desktop workstation. Authoring forms for a clinical study consists of defining the scheduled and unscheduled events in the study and the forms that will be collected during each of these events. In turn, a form definition consists of the fields, the validation rules for each field, the definition of code lists for those fields that require them, how each field in the form will be grouped into related fields that are presented together.

When the study definition is complete, it is converted into a Study Protocol Description (19) and saved to the Persistent Design Repository (11). The authoring tool (10a, 10b) saves the Study Protocol Description (19) to the design repository by opening a network connection to the Persistent Design Repository and authenticating. Then the authoring tool (10a, 10b) uploads the Study Protocol Definition (19) to the Persistent Design Repository (11) where it is stored.

### USE CASE # 4—UPDATING EXISTING FORMS FOR CLINICAL STUDIES

If the Study Protocol Description (19) is updated after the Target Application Binary (15) has been generated and deployed to the destination platform, a new Target Application Binary (15) reflecting the updated study protocol definition must be re-generated and re-deployed. When the Study Protocol Description (19) is updated in the authoring tool (10a, 10b, FIG. 1), the authoring tool keeps track of the changes and how they differ from the original definition. When all the changes have been made, the authoring tool creates a difference list, or list of changes made to the original study definition; the updated study definition can be obtained by starting with the original study definition and applying the modifications in the difference list. The new Study Protocol Description (19) and the difference list are saved to the Persistent Design Repository (11).

Once the updated Study Protocol Description (19) study definition has been saved to the Design Repository (11), Because the Design Repository (11) still has the complete definition for both the original and the updated studies, the Generator (12) may optionally generate support for both the original as well as the updated study in the new Target Application Source Code (13). The work essentially consists of generating two sets of Target Application Source Code (13), one for each version of the Study Protocol Description (19), target applications for both studies and packaging them into a single application deployment unit for the destination platform.

When the Target Application Binary (15) is updated, the present invention relies on a system administrator to facilitate the deployment of the updated information to the destination platform. Destination platforms frequently have a unique mechanism for deploying applications; in the case of J2ME-capable devices, each hardware manufacturer has a proprietary method for deploying J2ME applications, either using desktop synchronization software or some variety of over-the-air deployment for wireless devices.

While certain exemplary embodiments have been described in detail and shown in the accompanying drawings, it is to be understood that such embodiments merely illustrate rather than restrict the broad invention, and that this invention is not to be limited to the specific arrangements and constructions shown and described, since various other modifications may occur to those with ordinary skill in the art.

1. A data collection and monitoring system, comprising:
a. a remote collection unit means for collecting medical data, validating said collected data, and storing data therein;
b. instruction means within the remote collection unit for guiding the user of the data collection and monitoring system through various procedural steps for the collection of data;
c. display means on the remote collection unit for displaying data, instruction windows and graphics pertaining to each protocol study to the user of the remote collection unit;
d. input means connected to the remote collection unit to allow the user of the remote collection unit the ability to interact with the data displayed in real time, wherein the user may edit the information shown on the display or input new information into the remote collection unit;
e. interface means connected to the remote collection unit for downloading new or updated protocol details from the design repository and uploading data from the remote collection unit to the data repository; and
f. a main computer system connected to the interface means for receiving the uploaded data for further processing and downloading new or modified collection instructions to the remote collection unit.

2. The method according to claim 1, wherein a method for defining parameters for data collection on the remote collection unit is defined, comprising the steps of:
a. creating, changing, or deleting protocol details, component parameters, and data values and storing those details, parameters, and values in a design repository;
b. generating a set of source code using the values stored in the design repository as input;
c. further generating a target application from the source code generated from the values stored in the design repository;
d. transforming the target application into a form that can be deployed on the remote collection unit; and
e. transmitting the transformed target application to the remote collection unit.

3. A method for consolidating data collected by the remote collection unit as recited in claim 2, comprising the steps of invoking a data import and export module to upload the collected data from the remote collection unit to one or more of a plurality of centralized data repositories.

4. A method for consolidating data collected by the remote collection unit as recited in claim 2, comprising the steps of:
a) invoking a data import and export module to upload the collected data in a hierarchical configuration from the remote collection unit to one or more of a plurality of site-managed data repositories; and
b) transmitting data from all site-managed data repositories to a centralized data repository.
